(19) United States
(12) Patent Application Publication
(10) Pub. No.: US 2010/0134249 A1
(43) Pub. Date: Jun. 3, 2010

(54) Document authentication device

(75) Inventors: Vyacheslav G. Pevgov, Odintsovo (RU); Yuri T. Timofeev, Moscow (RU)

Correspondence Address: HOUSTON ELISEEVA, 4 MILITIA DRIVE, SUITE 4, LEXINGTON, MA, 02421, US

(73) Assignee: OOO "NOVYE ENERGETICHESKIE TEKHNOLOGII", Moscow (RU)

(21) Appl. No.: 12/425,845

(22) Filed: Apr. 17, 2009

(30) Foreign Application Priority Data
Apr. 18, 2008 (RU) 2008114774

(51) Int. Cl. G06F 7/04

(52) U.S. Cl. 340/5.86

(57) ABSTRACT

The invention relates to the field of the authentication of valuable securities and documents, preliminarily protected in a specific way. The technical result of the present invention is an increase in the signal to noise ratio. The technical result is achieved by the fact that, additionally introduced into a device containing a control and processing device; a receiver of the image of the document to be investigated, connected to a control and processing device; and an optical image reception system optically connected with the receiver of the image of the document to be investigated, are a laser intensifier of the document image, intended for brightening of the document to be investigated and the intensification of the brightness of the radiation reflected from the document to be investigated; a power supply of the laser intensifier of the document image, connected with the control and processing device mentioned, the control and processing device being intended for control of the operation of the laser intensifier of the document image and of the receiver of the image of the document to be investigated and for the processing of the image of the document to be investigated received by the receiver.

### RELATED APPLICATIONS

This application claims priority to Russian Patent Application No. RU 2008114774, filed Apr. 18, 2008, which is incorporated herein by reference in its entirety.

### FIELD OF THE INVENTION

The invention relates to the field of the authentication of valuable securities, documents, and other articles, preliminarily protected in a specific way, that moderately absorb radiation of the visible and near-infrared region of the spectrum.

### BACKGROUND OF THE INVENTION

In recent years, the very rapid development of computer technology has also contributed to the creation of advanced automated spectroscopic systems. Such systems make possible the automated investigation of the optical and luminescent properties of objects over a wide spectral range. In particular, this relates to the detectability of the existing optical means of protecting valuable securities and documents that have to a large extent been developed on the basis of optical spectroscopic methods. The existing means of protection employ classical dyes and luminophors that can, when they are detected, be used for the fabrication of counterfeit copies of protected objects.

The creation of quantum electronics has opened up the possibility of developing laser brightness intensifiers. It has turned out that pulsed metal vapor (copper, gold, barium, lead, and a number of other) lasers have suitable characteristics.

In a laser projection microscope, a tube with a brightness intensifier simultaneously faintly illuminates the object and, intensifying the light (carrying all information about it) reflected from it, provides bright screen illumination. In the process, the brightness is increased up to 10 thousand-fold. The entire system operates in just the space of brief pulses whose duration is several tens of nanoseconds. The pulse repetition frequency may reach several kilohertz, which means that several tens of thousands of objects can be examined per second. In particular complex cases, several trigger pulses of the laser brightness intensifier may be spent on one object.

Bright images of microobjects with up to 15 thousand-fold magnification on a screen of up to twenty-five square meters have been obtained by means of a copper vapor intensifier. All this lies far beyond the limits of the capabilities of ordinary optical systems. Optical systems with brightness intensifiers are a new field of contemporary optics.

The lack of brightness intensifiers has held back the solution of a general and highly pressing problem—the miniaturization of the recording of large volumes of information. At the present time, the capability for such recording does exist—holography, for example, permits the recording of one line of typed text on an area of approximately one square millimeter.

But there is another aspect of this problem—the extraction of information from these superminiature volumes. For just like the object under the microscope, the information carrier (for example, film) cannot withstand the strong illumination required for large magnification. The use of brightness intensifiers would eliminate many of these difficulties.

### SUMMARY OF THE INVENTION

Since laser intensifiers are the only extant brightness intensifiers of objects, and moreover the intensification reaches 10⁴, individual nanoparticles can be detected through their use, which is impossible by other methods.

For this reason, the achievement of the following is possible:

1. The use of a small number of markers;

2. It is possible from a fairly small number of markers to form an image which is impossible to detect by other methods.

A document authentication device is known in prior art (Utility Model Certificate RU 11619, 01.03.1999), which was selected as a prototype, and in which an optical means of recognition of markers that are visible only in infrared light is realized. An electronic-optical converter that converts invisible infrared radiation containing information about the document to be protected into the visible range, which makes it possible to visualize latent markers, was introduced into the optical system to simplify the process of identification in this device.

Such a device does not increase the brightness of the image, but simply shifts it to a different spectral range. The noise characteristics of the signal can only grow worse in the process.

The technical result of the present invention is an increase in the signal to noise ratio.

The technical result is achieved by the fact that, additionally introduced into a document authentication device containing a control and processing device; a receiver of the image of the document to be investigated, connected to a control and processing device; and an optical image reception system optically connected with the receiver of the image of the document to be investigated, are a laser intensifier of the document image, intended for brightening of the document to be investigated and the intensification of the brightness of the radiation reflected from the document to be investigated; a power supply of the laser intensifier of the document image, connected with the control and processing device mentioned, the control and processing device being intended for control of the operation of the laser intensifier of the document image and of the receiver of the image of the document to be investigated and for the processing of the image of the document to be investigated received by the receiver.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

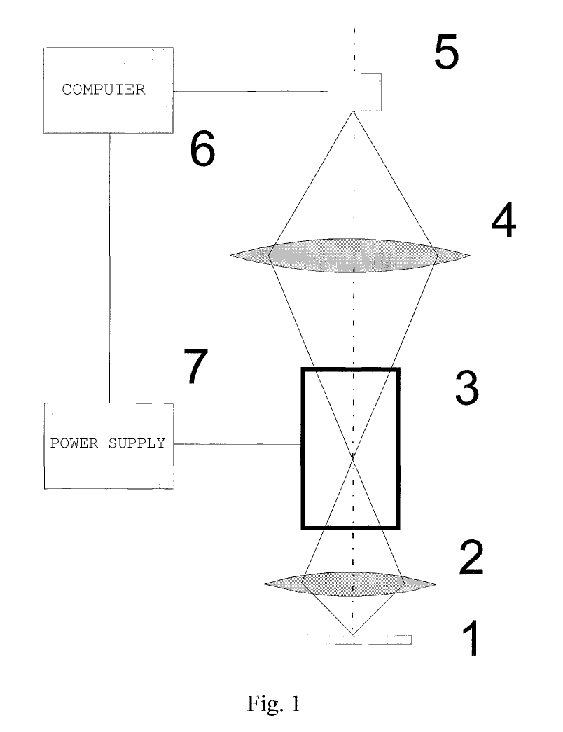

A diagram of the device applied for is represented in FIG. 1, where 1—is the protected document to be inspected, 2—the objective of the receiving system, 3—the laser image intensifier, 4—the optical system of the receiver of the image, 5—the receiver of the image, 6—the system of control and processing of signals, 7—the power supplies of the laser image intensifier.

### DETAILED DESCRIPTION OF THE PREFERRED EMBODIMENTS

The device operates in the following manner: upon command from the system of control and processing of signals (6), signals are delivered synchronously to the power supply (7) and to the receiver of the image (5) for the start of the operating cycle. Following receipt of an electrical pumping pulse from the power supply (7), spontaneous radiation from excited levels of the laser intensifier (3) through the objective (2) falls on the protected object to be examined (1). The radiation reflected from the protected object to be examined (1) returns through the objective (2), is intensified in the laser intensifier (3), and through the optical system (4) falls on the receiver of the image (5). After the signal is processed in the system of control and processing of signals (6), a decision is made regarding the authenticity of the object to be inspected.

The device employs advances in quantum electronics, makes it possible to work with valuable securities, documents, and other articles, with the use of the minimum number of nanoparticles, within the limits of several units or tens of items.

The laser intensifier increases the brightness of the image in a narrow spectral region several thousand-fold, whereas in the remaining region of the spectrum, which determines the noise component for the signal being investigated, such intensification does not occur or occurs with substantially lower effectiveness. This fact makes it possible to increase the signal to noise ratio and to recognize useful signals which cannot be obtained by classical methods, as they are buried in the noises.

We are proposing to use a laser intensifier that can improve the noise characteristics of signals in place of an electronic-optical converter, consequently facilitating the process of marker recognition substantially.

While this invention has been particularly shown and described with references to preferred embodiments thereof, it will be understood by those skilled in the art that various changes in form and details may be made therein without departing from the scope of the invention encompassed by the appended claims.

What is claimed is:

1. A document authentication device comprising:
a control and processing device;
a receiver of an image of the document to be investigated connected to the control and processing device; and
an optical image reception system optically connected with the receiver of the image of the document to be investigated,
wherein the document authentication device comprises:
a laser intensifier of the image of the document for brightening of the document to be investigated and for the intensifying the brightness of the radiation reflected from the document to be investigated;
a power supply of the laser intensifier of the image of the document, the power supply being coupled with the control and processing device, the control and processing device serving to control the operation of the laser intensifier of the image of the document and of the receiver of the image of the document to be investigated, and for the processing of the image of the document to be investigated received by the receiver.
